(19) United States
(12) Patent Application Publication
(10) Pub. No.: US 2024/0416235 A1
(43) Pub. Date: Dec. 19, 2024

(54) NON-TRANSITORY STORAGE MEDIUM, GAME APPARATUS, GAME SYSTEM, AND GAME METHOD

(71) Applicant: NINTENDO CO., LTD., Kyoto (JP)

(72) Inventors: Nobuo MATSUMIYA, Kyoto (JP); Yasuhiro MASUOKA, Tokyo (JP); Yusuke OIKAWA, Tokyo (JP)

(21) Appl. No.: 18/743,580

(22) Filed: Jun. 14, 2024

(30) Foreign Application Priority Data
Jun. 16, 2023 (JP) 2023-099696

(51) Int. Cl. A63F 13/5258; A63F 13/5378

(52) U.S. Cl. CPC A63F 13/5258; A63F 13/5378

(57) ABSTRACT

A non-transitory storage medium, a game apparatus, a game system and a game method is provided. One or more processors may control a player character in a field in a three-dimensional virtual space based on an operation input; move a first virtual camera according to a movement of the player character; generate a first image in the three-dimensional virtual space containing a first object constituting the field, based on the first virtual camera; generate a second image in the three-dimensional virtual space containing a second object outside an imaging area of the first virtual camera, based on a second virtual camera that moves in conjunction with the first virtual camera; and generate a game image through combining the first and second images.

### CROSS REFERENCE TO RELATED APPLICATION

This nonprovisional application is based on Japanese Patent Application No. 2023-99696 filed with the Japan Patent Office on Jun. 16, 2023, the entire contents of which are hereby incorporated by reference.

### FIELD

The present disclosure relates to a technique to generate a game image.

### BACKGROUND AND SUMMARY

Conventionally, there has been known image processing for generating an image of an object in a three-dimensional virtual space viewed from a predetermined point of view. Japanese Patent Laid-Open Application No. 2003-337957 discloses an image processing method for applying visual effects around an object in a three-dimensional virtual space.

Japanese Patent Laid-Open Application No. 2003-337957 discloses that, for example, when visual effects are to be displayed, boards to which the visual effects are applied are arranged in front of a virtual camera that captures an object from various points of view, and they are combined with a main image to display the visual effects.

The image processing method described in Japanese Patent Laid-Open Application No. 2003-337957 would need to prepare still images for the combining in advance. This would cause a high development cost because a lot of different visual effects are required to be prepared if, for example, the visual effect expression is to be changed according to the movement of the virtual camera.

A purpose of the present disclosure made in view of the above-mentioned background is to provide a new method of adding effects to an object in a three-dimensional virtual space.

### Configuration 1

A non-transitory computer-readable storage medium of Configuration 1 has stored therein instructions that, when executed by a processor of an information processing apparatus, cause the information processing apparatus to perform: a player character control process for controlling a player character in a field in a three-dimensional virtual space based on an operation input; a first virtual camera movement process for moving a first virtual camera according to a movement of the player character; a first image generation process for generating a first image in the three-dimensional virtual space containing a first object constituting the field, based on the first virtual camera; a second image generation process for generating a second image in the three-dimensional virtual space containing a second object outside an imaging area of the first virtual camera, based on a second virtual camera that moves in conjunction with the first virtual camera; and an image combining process for generating a game image through combining the first and second images.

This configuration allows the first image generated based on the first virtual camera to be combined with the second image generated based on the second virtual camera that moves in conjunction with the first virtual camera, and therefore allows the second image to be added as an effect to the first image. Changing the expression of the effect just requires changing the second object, and therefore the development cost can be reduced without the need to prepare many still images for the combining in advance.

### Configuration 2

In the non-transitory computer-readable storage medium according to Configuration 1, the first image generation process may comprise using a Z-buffer to generate the first image, and the image combining process may comprise: enlarging or reducing a texture constituting the second image based on a depth value stored in the Z-buffer for a corresponding position in the the first image; and generating the game image through combining the enlarged or reduced second image with the first image.

Enlarging or reducing a texture of the second image using a depth value as just described allows for creating a representation like projection mapping where the second image is projected onto an object in the first image.

### Configuration 3

In the non-transitory computer-readable storage medium according to Configuration 1 or 2, the image combining process may comprise: horizontally shifting a texture of a predetermined area in the second image; and then combining the second image with the first image. This configuration allows for creating an effect simulating noise generation in the second image. For example, the generation of noise resembling synchronization errors can bring the effect closer to real projection mapping.

### Configuration 4

In the non-transitory computer-readable storage medium according to Configuration 3, the image combining process may comprise: referring to a reference image containing one or more horizontally extending lines; horizontally shifting the texture of the predetermined area corresponding to the lines contained in the reference image; and then combining the second image with the first image. This allows for distorting the predetermined area horizontally with a simple configuration.

### Configuration 5

In the non-transitory computer-readable storage medium according to Configuration 4, the image combining process may comprise vertically scrolling the one or more horizontally extending lines contained in the reference image. This allows for vertically moving the predetermined area to be distorted horizontally.

### Configuration 6

In the non-transitory computer-readable storage medium according to any of Configurations 1 to 5, the image combining process may comprise: changing an enlargement factor of a texture for each of a plurality of channels constituting the second image; and then generating the game image through combining the second image with the first image. This configuration allows for producing the appearance of chromatic aberration with a simple configuration.

### Configuration 7

In the non-transitory computer-readable storage medium according to any of Configurations 1 to 6, the image combining process may comprise: determining dark and bright sections of the first object based on a virtual light source in the three-dimensional virtual space and on a normal vector to a surface constituting the first object; and shading an area in the game image corresponding to the dark section. This configuration prevents details of the first object from becoming difficult to discern due to the combining of the first and second images.

### Configuration 8

The non-transitory computer-readable storage medium according to Configuration 7 may be configured such that the shading is not applied to an area combined with an area in the second image with a predetermined brightness or higher, in the image combining process. This configuration prevents the image from becoming unnatural due to shading applied to its bright areas.

### Configuration 9

In the non-transitory computer-readable storage medium according any of Configurations 1 to 8, the first image generation process may comprise using a Z-buffer to generate the first image, the second image generation process may comprise generating a plurality of second images with different mipmap levels, and the image combining process may comprise: determining a first mipmap level of a texture corresponding to the second object based on a depth value stored in the Z-buffer for a corresponding area in the the first image; choosing the determined first mipmap level for a first area having a predetermined depth value; choosing a second mipmap level with lower resolution than the determined first mipmap level for a second area with a depth value other than the predetermined depth value; and combining textures corresponding to the chosen mipmap levels with the first image. This configuration allows for creating an effect simulating defocus where focus is achieved in an area having a predetermined depth and is not in other areas.

### Configuration 10

A game apparatus of Configuration 10 comprises a processor and a memory coupled thereto, the processor being configured to control the game apparatus to at least perform: a player character control process for controlling a player character in a field in a three-dimensional virtual space based on an operation input; a first virtual camera movement process for moving a first virtual camera according to a movement of the player character; a first image generation process for generating a first image in the three-dimensional virtual space containing a first object constituting the field, based on the first virtual camera; a second image generation process for generating a second image in the three-dimensional virtual space containing a second object outside an imaging area of the first virtual camera, based on a second virtual camera that moves in conjunction with the first virtual camera; and an image combining process for generating a game image through combining the first and second images.

### Configuration 11

In the game apparatus according to Configuration 10, the first image generation process may comprise using a Z-buffer to generate the first image, and the image combining process may comprise: enlarging or reducing a texture constituting the second image based on a depth value stored in the Z-buffer for a corresponding position in the the first image; and generating the game image through combining the enlarged or reduced second image with the first image.

### Configuration 12

In the game apparatus according to Configuration 10 or 11, the image combining process may comprise: horizontally shifting a texture of a predetermined area in the second image; and then combining the second image with the first image.

### Configuration 13

In the game apparatus according to Configuration 12, the image combining process may comprise: referring to a reference image containing one or more horizontally extending lines; horizontally shifting the texture of the predetermined area corresponding to the lines contained in the reference image; and then combining the second image with the first image.

### Configuration 14

In the game apparatus according to Configuration 13, the image combining process may comprise vertically scrolling the one or more horizontally extending lines contained in the reference image.

### Configuration 15

In the game apparatus according to any of Configurations 10 to 14, the image combining process may comprise: changing an enlargement factor of a texture for each of a plurality of channels constituting the second image; and then generating the game image through combining the second image with the first image.

### Configuration 16

In the game apparatus according to any of Configurations 10 to 15, the image combining process may comprise: determining dark and bright sections of the first object based on a virtual light source in the three-dimensional virtual space and on a normal vector to a surface constituting the first object; and shading an area in the game image corresponding to the dark section.

### Configuration 17

The game apparatus according to any of Configurations 10 to 16 may be configured such that the shading is not applied to an area combined with an area in the second image with a predetermined brightness or higher, in the image combining process.

### Configuration 18

In the game apparatus according to any of Configurations 10 to 17, the first image generation process may comprise using a Z-buffer to generate the first image, the second image generation process may comprise generating a plurality of second images with different mipmap levels, and the image combining process may comprise: determining a first mipmap level of a texture corresponding to the second object based on a depth value stored in the Z-buffer for a corresponding area in the the first image; choosing the determined first mipmap level for a first area having a predetermined depth value; choosing a second mipmap level with lower resolution than the determined first mipmap level for a second area with a depth value other than the predetermined depth value; and combining textures corresponding to the chosen mipmap levels with the first image.

### Configuration 19

A game system of Configuration 19 comprises a server apparatus and a user terminal connected to each other via a network, the user terminal comprising a processor and a memory coupled thereto, the processor being configured to control the user terminal to at least perform: an input process for accepting an operation input from a user; a communications process for sending input operation information to the server apparatus as well as receiving game information sent from the server apparatus; and a display process for displaying a game image, the server apparatus comprising a processor and a memory coupled thereto, the processor being configured to control the server apparatus to at least perform: a communications process for receiving operation information sent from the user terminal as well as sending game information to the user terminal; a player character control process for controlling a player character in a field in a three-dimensional virtual space based on operation information of the user; a first virtual camera movement process for moving a first virtual camera according to a movement of the player character; a first image generation process for generating a first image in the three-dimensional virtual space containing a first object constituting the field, based on the first virtual camera; a second image generation process for generating a second image in the three-dimensional virtual space containing a second object outside an imaging area of the first virtual camera, based on a second virtual camera that moves in conjunction with the first virtual camera; and an image combining process for generating a game image through combining the first and second images.

### Configuration 20

In the game system according to Configuration 19, the first image generation process may comprise using a Z-buffer to generate the first image, and the image combining process may comprise: enlarging or reducing a texture constituting the second image based on a depth value stored in the Z-buffer for a corresponding position in the the first image; and generating the game image through combining the enlarged or reduced second image with the first image.

### Configuration 21

In the game system according to Configuration 19 or 20, the image combining process may comprise:

horizontally shifting a texture of a predetermined area in the second image; and then combining the second image with the first image.

### Configuration 22

In the game system according to Configuration 21, the image combining process may comprise: referring to a reference image containing one or more horizontally extending lines; horizontally shifting the texture of the predetermined area corresponding to the lines contained in the reference image; and then combining the second image with the first image.

### Configuration 23

In the game system according to Configuration 22, the image combining process may comprise vertically scrolling the one or more horizontally extending lines contained in the reference image.

### Configuration 24

In the game system according to any of Configurations 19 to 23, the image combining process may comprise: changing an enlargement factor of a texture for each of a plurality of channels constituting the second image; and then generating the game image through combining the second image with the first image.

### Configuration 25

In the game system according to any of Configurations 19 to 24, the image combining process may comprise: determining dark and bright sections of the first object based on a virtual light source in the three-dimensional virtual space and on a normal vector to a surface constituting the first object; and shading an area in the game image corresponding to the dark section.

### Configuration 26

The game system according to any of Configurations 19 to 25 may be configured such that the shading is not applied to an area combined with an area in the second image with a predetermined brightness or higher, in the image combining process.

### Configuration 27

In the game system according to any of Configurations 19 to 26, the first image generation process may comprise using a Z-buffer to generate the first image, the second image generation process may comprise generating a plurality of second images with different mipmap levels, and the image combining process may comprise: determining a first mipmap level of a texture corresponding to the second object based on a depth value stored in the Z-buffer for a corresponding area in the the first image; choosing the determined first mipmap level for a first area having a predetermined depth value; choosing a second mipmap level with lower resolution than the determined first mipmap level for a second area with a depth value other than the predetermined depth value; and combining textures corresponding to the chosen mipmap levels with the first image.

### Configuration 28

A game method of Configuration 28 is for generating a game image using a computer of an information processing apparatus, and the game method comprises the steps of: the computer controlling a player character in a field in a three-dimensional virtual space based on an operation input; the computer moving a first virtual camera according to a movement of the player character; the computer generating a first image in the three-dimensional virtual space containing a first object constituting the field, based on the first virtual camera; the computer generating a second image in the three-dimensional virtual space containing a second object outside an imaging area of the first virtual camera, based on a second virtual camera that moves in conjunction with the first virtual camera; and the computer generating a game image through combining the first and second images.

### Configuration 29

In the game method according to Configuration 28, the first image generation step may comprise using a Z-buffer to generate the first image, and the game image generation step may comprise: enlarging or reducing a texture constituting the second image based on a depth value stored in the Z-buffer for a corresponding position in the the first image; and generating the game image through combining the enlarged or reduced second image with the first image.

### Configuration 30

In the game method according to Configuration 28 or 29, the game image generation step may comprise: horizontally shifting a texture of a predetermined area in the second image; and then combining the second image with the first image.

### Configuration 31

In the game method according to Configuration 30, the game image generation step may comprise: referring to a reference image containing one or more horizontally extending lines; horizontally shifting the texture of the predetermined area corresponding to the lines contained in the reference image; and then combining the second image with the first image.

### Configuration 32

In the game method according to Configuration 31, the game image generation step may comprise vertically scrolling the one or more horizontally extending lines contained in the reference image.

### Configuration 33

In the game method according to any of Configurations 28 to 32, the game image generation step may comprise: changing an enlargement factor of a texture for each of a plurality of channels constituting the second image; and then generating the game image through combining the second image with the first image.

### Configuration 34

In the game method according to any of Configurations 28 to 33, the game image generation step may comprise: determining dark and bright sections of the first object based on a virtual light source in the three-dimensional virtual space and on a normal vector to a surface constituting the first object; and shading an area in the game image corresponding to the dark section.

### Configuration 35

The game method according to any of Configurations 28 to 34 may be configured such that the shading is not applied to an area combined with an area in the second image with a predetermined brightness or higher, in the game image generation step.

### Configuration 36

In the game method according to any of Configurations 28 to 35, the first image generation step may comprise using a Z-buffer to generate the first image, the second image generation step may comprise generating a plurality of second images with different mipmap levels, and the game image generation step may comprise: determining a first mipmap level of a texture corresponding to the second object based on a depth value stored in the Z-buffer for a corresponding area in the the first image; choosing the determined first mipmap level for a first area having a predetermined depth value; choosing a second mipmap level with lower resolution than the determined first mipmap level for a second area with a depth value other than the predetermined depth value; and combining textures corresponding to the chosen mipmap levels with the first image.

The foregoing and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is a block diagram showing an example of a hardware configuration of a game apparatus of an embodiment;

FIG. 2 is a memory map showing an example of various data stored in a storage of the game apparatus;

FIG. 3 shows modules comprising a game program;

FIG. 4 illustrates a basic process of an image combining process performed by the game apparatus of the embodiment;

FIG. 5 illustrates the basic process of the image combining process performed by the game apparatus of the embodiment;

FIG. 6A shows an example of an image in which projection mapping is performed;

FIG. 6B shows an example of an image in which projection mapping is performed;

FIG. 6C shows an example of an image in which projection mapping is performed;

FIG. 7 shows an example of a game image with a horizontal distortion;

FIG. 8 shows an example of a reference image;

FIG. 9 shows an example of chromatic aberration;

FIG. 10A shows an example in which details are lost due to image combining;

FIG. 10B shows an example of a game image to which shading is applied;

FIG. 11 shows an operation of the game apparatus of the embodiment; and

FIG. 12 shows a configuration of a game system of an embodiment.

### MODES OF EMBODYING THE INVENTION

A game program and a game apparatus of an embodiment will now be described with reference to the drawings. The following description is merely illustrative of preferred modes, and is not intended to limit the invention described in the claims.

### First Embodiment

A game apparatus of a first embodiment is installed with a game program that represents projection mapping in a game. Projection mapping is a technique to use a projector to project images in a space or on objects and give a variety of visual effects to the overlayed images. The game apparatus of the embodiment creates a representation like projection mapping projected onto objects in a three-dimensional virtual space.

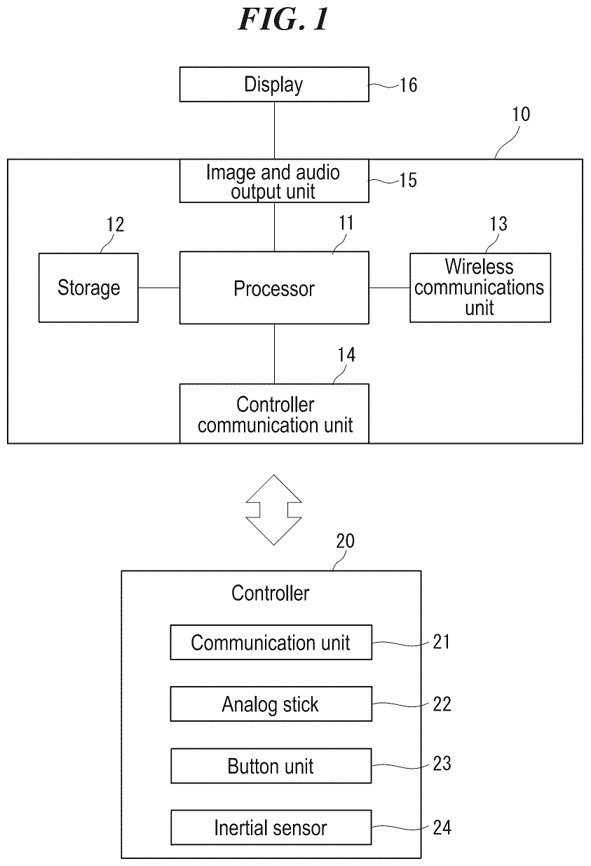

FIG. 1 is a block diagram showing an example of a hardware configuration of the game apparatus 10 of the embodiment. The game apparatus 10 is, for example, a smartphone, a stationary or portable game apparatus, a tablet terminal, a portable phone, a personal computer, a wearable terminal, or the like. Information processing of the embodiment can be applied to a game system comprising such a game apparatus described above or the like and a predetermined server apparatus. A stationary game apparatus (hereinafter referred to as the game apparatus) is described in the embodiment as an example.

In FIG. 1, the game apparatus 10 has a processor 11. The processor 11 is an information processing unit for executing various kinds of information processing performed on the game apparatus 10, and may comprise, for example, a CPU (Central Processing Unit) only, or an SoC (System-on-a-Chip) including a plurality of functions such as a CPU function and a GPU (Graphics Processing Unit) function. The processor 11 executes an information processing program (e.g., a game program) stored in a storage 12 and thereby performs the various kinds of information processing. The storage 12 may be, for example, an internal storage medium such as a flash memory and a DRAM (Dynamic Random Access Memory), or configured to use an external storage medium inserted into a not-shown slot or the like.

The game apparatus 10 has a wireless communications unit 13 for wirelessly communicates with other game apparatuses 10 and a predetermined server apparatus. Internet communications and short-range wireless communications, for example, are used as the wireless communications. The game apparatus 10 also has a controller communication unit 14 for performing wire or wireless communication with a controller 20.

The game apparatus 10 is connected with a display 16 (e.g., a television) via an image and audio output unit 15. The processor 11 outputs generated images and audio (e.g., generated by the above-mentioned information processing being performed) via the image and audio output unit 15 to the display 16.

The controller 20 will be described next. Though not shown, the controller 20 of the embodiment has a vertically long housing, and can be gripped in a portrait orientation. The housing has a shape and size that can be gripped with one hand when gripped in a portrait orientation.

The controller 20 has at least one analog stick 22, which is an example of a direction input device. The analog stick 22 can be used as a direction input unit that can input directions. Through tilting the analog stick 22, a user can input a direction according to the direction of tilt (and the intensity according to the angle of tilt). The controller 20 also has a button unit 23 including various operation buttons. For example, the controller 20 may have a plurality of operation buttons on a main surface of the housing described above. The operation buttons include, for example, an ABXY button, a plus button, a minus button, an L button, and an R button.

The controller 20 also has an inertial sensor 24. Specifically, the controller 20 has an acceleration sensor and an angular rate sensor as the inertial sensor 24. In the embodiment, the acceleration sensor measures the acceleration along three predetermined axes. The angular rate sensor detects the angular rate around the three predetermined axes.

The controller 20 also has a communication unit 21 for performing wire or wireless communication with the controller communication unit 14 described above. A direction input to the above-described analog stick 22, information indicating how the buttons of the button unit 23 are pressed, and various detection results obtained by the inertial sensor 24 are output to the communication unit 21 and sent to the game apparatus 10 in a timely manner and repeatedly.

### (Data Stored in the Game Apparatus)

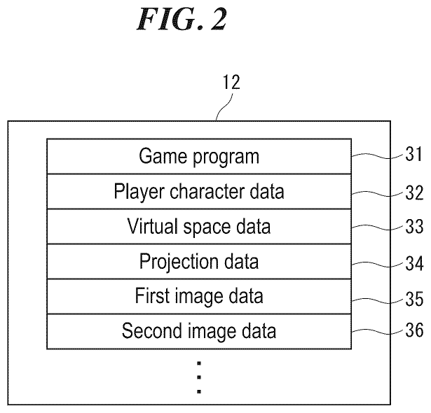

Data stored in the game apparatus 10 will be described next. FIG. 2 is a memory map showing an example of various data stored in the storage 12 of the game apparatus 10. The storage 12 of the game apparatus 10 contains a game program 31, player character data 32, virtual space data 33, projection data 34, first image data 35, second image data 36, and the like.

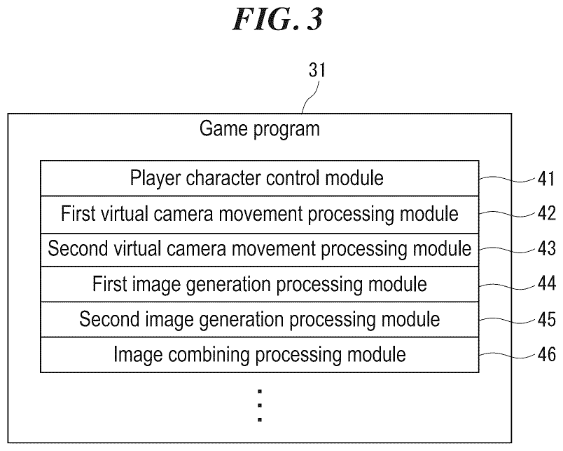

The game program 31 is a program for performing game processing of the embodiment. The game program 31 will be described later with reference to FIG. 3. The player character data 32 is data on a character of a player. The player character data 32 includes, for example, a player character's appearance, ability, experience points, and inventory items. The virtual space data 33 is data on a three-dimensional virtual space constituting the world of the game (hereinafter referred to as the “game world”). The virtual space data 33 includes data on objects such as geographical features.

The projection data 34 is data on a three-dimensional virtual space containing objects to be projected onto the game world (hereinafter referred to as the “projection world”). The projection world corresponds to the game world, and the virtual spaces have corresponding coordinates. An object being in a certain position in the projection world is combined with the game world at the same predetermined position.

The three-dimensional virtual space constituting the game world and the three-dimensional virtual space constituting the projection world are the same three-dimensional virtual space in the embodiment. They, however, may be different virtual spaces. In other words, objects to be projected may be placed in a virtual space other than the three-dimensional virtual space of the game world.

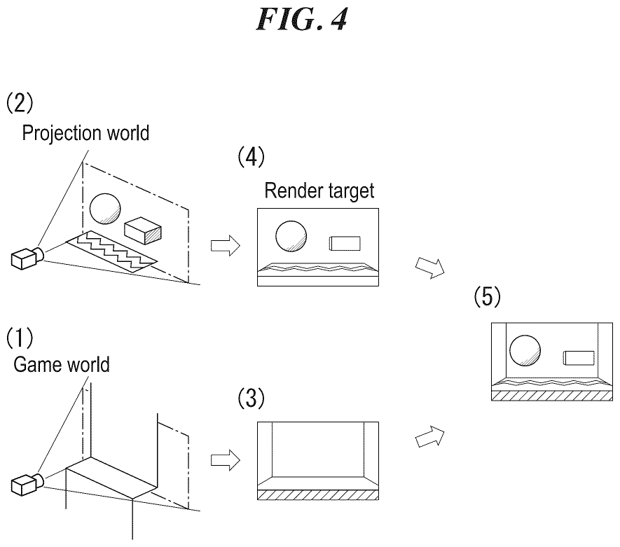

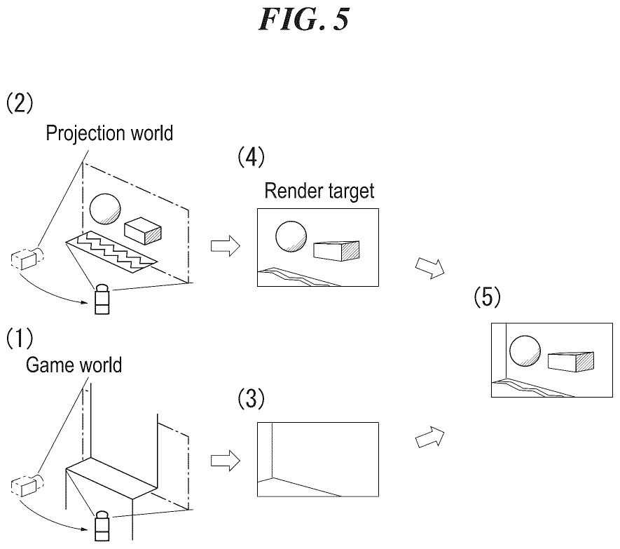

FIGS. 4 and 5 illustrate a basic process of an image combining process performed by the game apparatus of the embodiment. FIG. 4 (1) shows the game world, and FIG. 4 (2) shows the projection world.

In the example shown in FIG. 4, the game world has an object constituting a stage. A player character can move on this stage. In the projection world, objects to be combined with the game world are arranged. The objects to be combined may be stationary or moving. When the objects are moved, they may be moved in association with the movement of a player character in the game world. For example, moving an object to be combined so that it comes close to a player character can realize an effect where the projected object follows the player character around in the game image generated by the combining.

While in this example the projection world does not have a stage object on which a character moves, the projection world may be provided with a determination area that restricts the movement of a character just like the game world.

As shown in FIG. 4 (1), the game world has a first virtual camera serving as a viewpoint for the game world. The position and orientation of the first virtual camera change according to the movement of a player character. The plane indicated by dash-dotted lines is an image of the game world viewed from the first virtual camera. An image of the game world captured by the first virtual camera (hereinafter referred to as a “game world image”) is, as shown in FIG. 4 (3), an image of the three-dimensional virtual space projected onto the image plane. A game world image corresponds to the first image. Note that, unlike shooting with a real camera, a game world image is generated by drawing an image of the three-dimensional virtual space projected onto the image plane.

As shown in FIG. 4 (2), the projection world has a second virtual camera serving as a viewpoint for the projection world. The position and orientation of the second virtual camera are in conjunction with the first virtual camera, and are the same as those of the first virtual camera. The synchronized movement of the first and second virtual cameras will be described with reference to FIG. 5.

FIG. 5 shows the same game world and projection world as FIG. 4. The difference from FIG. 4 is that the first and second virtual cameras have moved to the right side of the stage in FIG. 5. As shown in FIG. 5 (1), the movement and rotation of the first virtual camera cause the three-dimensional virtual space to be projected onto the plane indicated by dash-dotted lines, resulting in an image of the stage viewed from an oblique angle as shown in (3). The second virtual camera in the projection world moves in conjunction with the first virtual camera, and views the projection world from the same position and direction as those of the first camera. The movement of the second virtual camera has revealed the side of a rectangular parallelepiped object in the projection world.

The plane indicated by dash-dotted lines is an image of the projection world viewed from the second virtual camera. An image of the projection world captured by the second virtual camera (hereinafter referred to as a “projection world image”) is, as shown in FIG. 5 (4), an image of the three-dimensional virtual space projected onto the image plane. A projection world image corresponds to the second image. A projection world image is also generated by drawing an image of the three-dimensional virtual space projected onto the image plane.

In the embodiment, the image of the game world generated based on the first virtual camera, (3), and the image of the projection world generated based on the second virtual camera, (4), are combined as a post-process effect to generate an image as shown in FIG. 4 (5).

The description of FIG. 2 will be resumed. As described above, the first image data 35 is data on a game world image of the game world viewed from the first virtual camera. The first virtual camera moves according to the movement of a player character. The second image data 36 is data on a projection world image of the projection world viewed from the second virtual camera. The second virtual camera moves in conjunction with the first virtual camera. Since the game world and the projection world correspond to each other, the synchronized movement of the first and second virtual cameras causes a game world image and a projection world image to be images of the game world and projection world shot from the same viewpoint and direction.

FIG. 3 shows modules comprising the game program 31. The game program 31 has a player character control module 41, a first virtual camera movement processing module 42, a second virtual camera movement processing module 43, a first image generation processing module 44, a second image generation processing module 45, and an image combining processing module 46. While the modules related to the image combining technique realized by the game apparatus 10 of the embodiment are shown in FIG. 3, the game program 31 has not-shown modules that perform processes required for making progress of the game.

The player character control module 41 has a function to control a player character in a field in the three-dimensional virtual space based on an operation input. The first virtual camera movement processing module 42 has a function to move the first virtual camera according to the movement of a player character. That is, the first virtual camera is moved according to a move of a player character so that an image viewed from the player character is displayed. The second virtual camera movement processing module 43 has a function to move and rotate the second virtual camera in conjunction with the first virtual camera. That is, the second virtual camera moves and rotates the same as the first virtual camera.

The first image generation processing module 44 has a function to generate a game world image containing geographical features or other objects constituting a field, based on the first virtual camera. The second image generation processing module 45 has a function to generate a projection world image of objects to be projected, based on the second virtual camera that moves in conjunction with the first virtual camera.

The image combining processing module 46 has a function to generate a game image through combining a game world image with a projection world image as a post-process effect. The basic process of combining a game world image and a projection world image is as described with reference to FIGS. 4 and 5, and more specifically, a game world image and a projection world image are combined by mapping a texture of the projection world image to the game world image. This mapping is called texture mapping. Textures of a projection world image are assigned U and V coordinates, where the horizontal direction is U and the vertical direction is V, and the U and V coordinates are used to specify what part of a game world image to combine with what part of a projection world image. When the first image is a polygon, U and V coordinates are specified for each vertex of the polygon.

The game program 31 performs various kinds of things in order to represent realistic projection mapping. Specifically, those are: giving perspective to a projected image; adding noise to a projected image; giving chromatic aberration to a projected image; shading to enhance the visibility of an object in the three-dimensional virtual space; and representing defocus in a projected image. Note that there is no need to perform all these representations, and they are selectable depending on the situation. The functions to represent realistic projection mapping will be described below in turn.

### (Perspective)

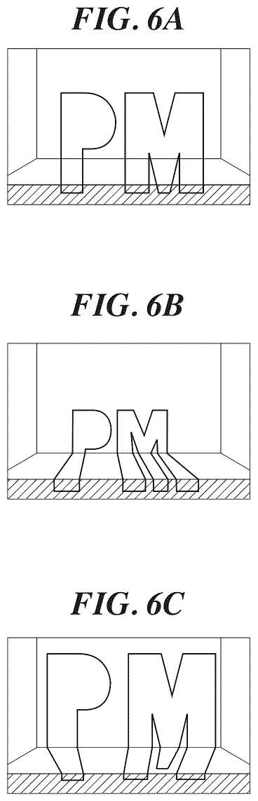

FIGS. 6A to 6C show examples of an image in which projection mapping is performed. The stage is a game world image. In those examples, a projection world image containing letters “PM” is projected to enhance perspective.

One ideal of real-world projection mapping is to map an image that makes letters appear to stand out regardless of the shape of a building or the like onto which the image is projected, as shown in FIG. 6A. In some cases, however, an image standing out of the background as a representation in the game does not appear as a projection. The game program 31 of the embodiment therefore uses depth information of the virtual space of the game world to give a pseudo perspective to an image to be combined.

The first image generation processing module 44 uses a Z-buffer to generate a game world image. In three-dimensional computer graphics, a technique of using depth (the distance between the front and the back) information to render an object is used in order to accelerate the rendering process. In this technique, an area of memory to store depth information is the Z-buffer.

The image combining processing module 46 enlarges or reduces a texture constituting a projection world image based on a depth value stored in the Z-buffer. Specifically, when mapping a texture of a projection world image to a game world image, the image combining processing module 46 enlarges or reduces the U and V coordinates to enlarge or reduce the texture of the projection world image to be combined with the game world image. The image combining processing module 46 sets a reference depth value in advance, and determines whether to enlarge or reduce the U and V coordinates depending on whether the depth value of a part to be combined with the projection world image is larger or smaller than the reference depth value.

FIG. 6B shows an example in which a projection world image is reduced as the depth value increases and the image of letters “PM” subjected to the reduction process is combined. In the example shown in FIG. 6B, the letters “PM” get thinner as they go deep, so that they appear to be projected onto the stage.

FIG. 6C shows an example in which a projection world image is enlarged as the depth value increases and the image of letters “PM” subjected to the enlargement process is combined. In the example shown in FIG. 6C, the letters “PM” get thicker as they go deep. This allows for a representation of projection mapping with radiant light.

As seen above, when a game world image and a projection world image are combined, an image to be projected onto the game image can be given perspective by a simple configuration in which the U and V coordinates are enlarged or reduced.

### (Noise)

Noise resembling video synchronization errors sometimes appears in real projection mapping. The game program 31 of the embodiment therefore simulates and adds this noise.

When combining a projection world image with a game world image, the image combining processing module 46 shifts the U direction of the U and V coordinates for a predetermined area in the projection world image. In the embodiment, the predetermined area is an elongated area extending from the left end to the right end of the projection world image. Shifting the U direction of the U and V coordinates for the predetermined area allows for a horizontal shift of the position of mapping of the projection world image to the game world image, resulting in an appearance of noise added in the horizontal direction in the game image.

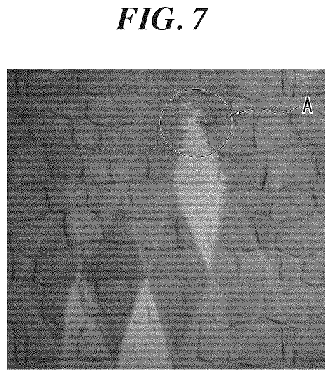

FIG. 7 shows an example of a game image with a horizontal distortion. As can be seen from an area enclosed by a circle, A, the upper part of a rhombic pattern is distorted horizontally. What area in the projection world image the horizontal noise is to be added to, that is, how to determine the predetermined area, is as follows. First, a reference image corresponding to the projection world image is prepared.

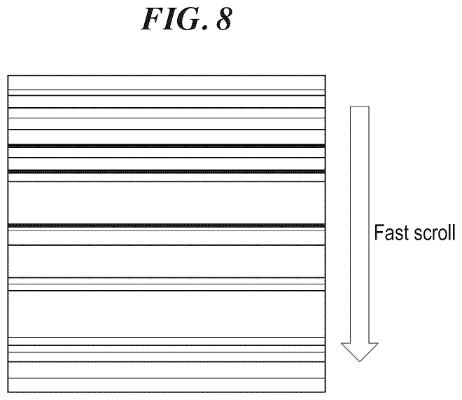

FIG. 8 shows an example of the reference image. The reference image comprises horizontally extending lines being scrolled vertically. These lines may be generated at random. The image combining processing module 46 refers to the reference image, determines an area in the projection world image corresponding to the lines to be the predetermined area, and shifts the U direction of the U and V coordinates of the projection world image for the predetermined area, thereby creating distortion in the projection world image. The degree of shifting the U direction may be determined depending on the thickness of each line in such a way that, for example, the shift is made greater when the line is thick than when the line is thin.

Since the lines are being scrolled downward fast in the reference image, the predetermined area corresponding to the lines is also scrolled downward fast. In other words, the area where distortion is created moves downward. In practice, noise can be represented by a representation like a momentary rough shift, resulting in a realistic projection mapping appearance.

In this way, realistic projection mapping can be represented by creating noise with a simple configuration in which the U direction of the U and V coordinates is shifted when a game world image and a projection world image are combined.

While the embodiment is described with the example in which the horizontally extending lines are being scrolled vertically in the reference image and the image combining processing module 46 determines an area to distort horizontally referring to this reference image, there may be a configuration, as a variation, in which the horizontally extending lines are not scrolled in the reference image. That is, the image combining processing module changes what coordinate (position in the vertical axis) to refer to in the reference image over time. The module performs processing in which the U direction of the U and V coordinates of a projection world image is shifted if there is a line drawn at the referenced coordinate and not shifted if not. This allows for vertically moving the area where distortion is created in the projection world image.

### (Chromatic Aberration)

The image combining processing module 46 may change the enlargement factor of the U and V coordinates of a texture for each of RGB channels constituting a projection world image and combine the textures of the channels with different enlargement factors with a game world image.

The enlargement factor is, for example, unity for the B channel, 0.99 for the G channel, and 1.01 for the R channel. That is, when an image of the B channel is combined, the U and V coordinates are used as is for mapping. When the G channel is combined, the U and V coordinates multiplied by 0.99 are used for mapping. When the R channel is combined, the U and V coordinates multiplied by 1.01 are used for mapping.

Assuming that the U and V coordinates of the center of the image are (0, 0), the difference in the U and V coordinate values between the G and R channels increases as the position gets farther from the center. Consequently, G deviates toward the center and R deviates outward as the position gets outward from the center in a game image resulted from combining the game world image and the projection world image, which results in an appearance of chromatic aberration occurring in the projection world image. This allows for a simple simulation of a lens and realistic projection mapping representation.

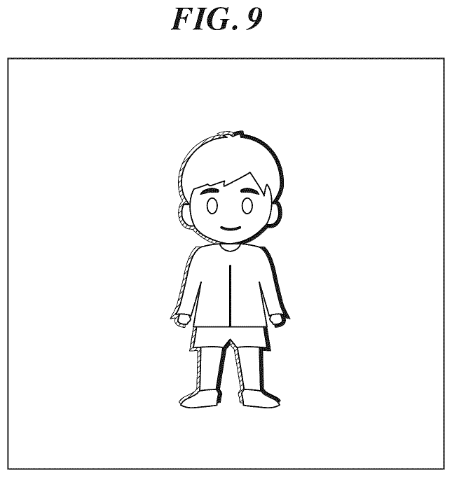

FIG. 9 shows an example of chromatic aberration. Green edge areas appear on the right side of a person's image, and red edge areas appear on the left side. Simply changing the enlargement factor of the U and V coordinates in this way allows for reproducing chromatic aberration with ease.

While the method is described here with the example in which chromatic aberration is increased as the position gets farther from the center, there may also be such a configuration as periodically varying the amount of shift.

### (Shade)

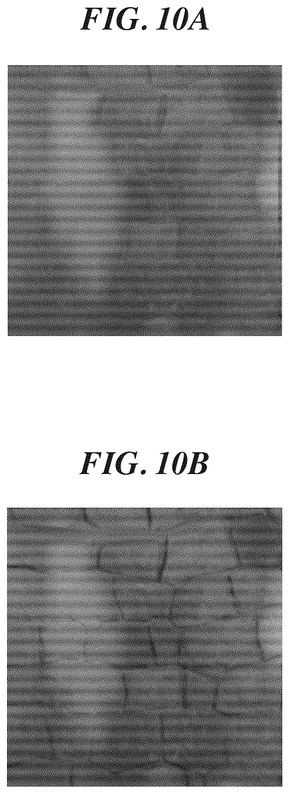

Combining a game world image with a projection world image may result in loss of detail in the game world image due to the projection world image. FIG. 10A shows an example in which details are lost due to image combining.

In FIG. 10A, the game world image has a brick pattern, but the boundaries between bricks are hard to see due to the combining with the projection world image. The image combining processing module 46 may apply shading to the game image to enhance the details of the game world image.

The image combining processing module 46 determines dark and bright sections of an object based on a virtual light source in the game world and on a normal vector to a surface constituting the object. A dark section is, for example, a shady area where light does not enter such as the boundaries between bricks, and an area where the angle between a ray of light from the virtual light source and a normal vector to an object surface is large. Therefore, dark and bright sections can be determined from the position of the virtual light source and a normal vector to an object surface.

As for normal vectors, for example, information on normal vectors in a G-buffer (geometry buffer) containing texture data is used. The image combining processing module 46 then shades an area in the game image corresponding to the dark section.

FIG. 10B shows an example of a game image to which shading is applied. The boundaries between bricks in the image shown in FIG. 10B, which are dark sections, are shaded, and are therefore more obvious than those in FIG. 10A.

The image combining processing module 46 may also be configured: to determine the brightness for each area in a projection world image; to shade an area in a game image combined with an area with a brightness lower than a predetermined brightness; and not to shade an area in the game image combined with an area with the predetermined brightness or higher. In real projection mapping, the background such as a building is likely to be less obvious in an area where intense light is projected. Shading a bright area would result in an even more unnatural image. A game image with unnatural shades can be prevented by not shading an area with the predetermined brightness or higher.

### (Defocus)

The image combining processing module 46 reproduces a state where focus is only on a certain depth and not on other depths, through changing the MIP level of a projection world image from its original MIP level according to the depth.

When generating a projection world image, the second image generation processing module 45 generates not only a main image but also a plurality of mipmap images whose areas are sequentially reduced to one-fourth from the main image. Mipmaps are a set of mipmap images, each of which has a progressively lower resolution of the previous, and those resolutions are called MIP levels.

When combining a game world image with a projection world image, the image combining processing module 46 determines which size of a mipmap image to combine based on a depth value stored in the Z-buffer for a corresponding position in the the game world image. Depth values and mipmap levels are usually correlated in such a way that an image of a high mipmap level (a high resolution mipmap) is used if the depth value is small and an image of a low mipmap level (a low resolution mipmap) is used if the depth value is large. Mipmap levels determined based on the correlation with the depth value in this way are herein referred to as “original mipmap levels.”

The function to represent defocus comprises choosing an original mipmap level for areas with a predetermined depth value and choosing mipmap levels lower than the original for other areas. This results in an image focused for the areas with the predetermined depth value and defocused for the other areas. Just changing the choice of mipmap levels thus allows for realizing a defocused image with ease.

Various functions of the game program 31 of the embodiment to represent realistic projection mapping have been described above. Every function is processing as a post-process effect after the generation of a game world image and a projection world image, and allows for a fast and realistic representation.

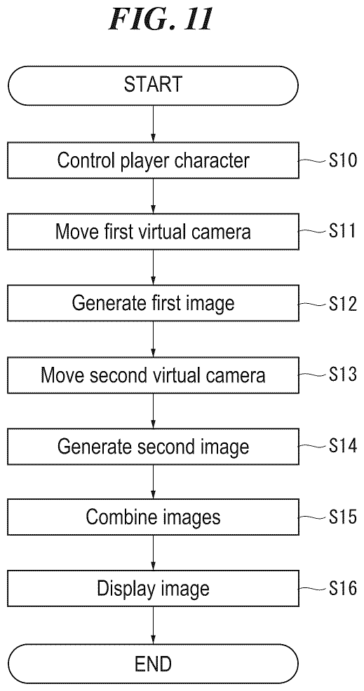

FIG. 11 shows an operation of the game apparatus 10 of the embodiment. The game apparatus 10 first accepts an operation input from a user, and controls a player character based on the input operation (S10). Following the control of the player character, the game apparatus 10 performs processing for moving the first virtual camera (S11), and generates a game world image containing the three-dimensional virtual space of the game world and the player character (S12). The game apparatus 10 also moves the second virtual camera in conjunction with the first virtual camera (S13), and generates a projection world image (S14). The game apparatus 10 combines the game world image and the projection world image through mapping the projection world image to the game world image (S15). When performing this image combining, the game apparatus 10 performs a chosen one of the various processes that make projection mapping look realistic. The game apparatus 10 displays the game image generated by the image combining on the game apparatus 10 (S16).

The above is a description of the game apparatus, the game method, and the game program of the first embodiment. With a simple configuration in which a game world image generated based on the first virtual camera is combined with a projection world image generated based on the second virtual camera that moves in conjunction with the first virtual camera, the game apparatus of the embodiment allows for adding a projection mapping effect to the game world image and reducing the development cost.

### Second Embodiment

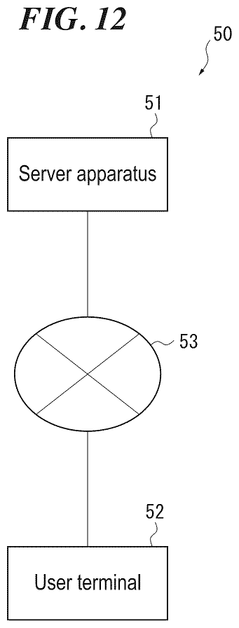

FIG. 12 shows a configuration of a game system 50 of a second embodiment. The game system 50 of the embodiment comprises a server apparatus 51 and a user terminal 52. The server apparatus 51 and the user terminal 52 are configured to be capable of communicating with each other via a network 53 such as the Internet. The user terminal 52 may be a game-specific apparatus, or may be a general-purpose apparatus including, for example, a smartphone, a tablet terminal, a portable phone, a personal computer, and a wearable terminal. While only one user terminal 52 is shown in FIG. 12, there may be a plurality of user terminals 52.

In the game system 50 of the embodiment, the server apparatus 51 has the functions of the game apparatus 10 described in the first embodiment. That is, the server apparatus 51 controls a player character based on an operation input from a user, performs processing for moving the first and second virtual cameras based on the movement of the player character, and generates a game image through combining a game world image and a projection world image which are generated based on the first and second virtual cameras.

The user terminal 52 accepts an operation input from a user, and sends the input operation information to the server apparatus 51. The server apparatus 51 generates a game image based on the operation information sent from the user terminal 52, and sends the generated game image as part of game information to the user terminal 52. The user terminal 52 displays the game image sent from the server apparatus 51.

In this way, a game image representing projection mapping can be generated easily even in the game system 50 comprising the server apparatus 51 and the user terminal 52. While the embodiment has been described with the example in which the server apparatus 51 handles from the player character control processing to the image combining processing, the division of functions between the server apparatus 51 and the user terminal 52 can be arbitrarily changed.

1. A non-transitory computer-readable storage medium having stored therein instructions that, when executed by a processor of an information processing apparatus, cause the information processing apparatus to perform:
a player character control process for controlling a player character in a field in a three-dimensional virtual space based on an operation input;
a first virtual camera movement process for moving a first virtual camera according to a movement of the player character;
a first image generation process for generating a first image in the three-dimensional virtual space containing a first object constituting the field, based on the first virtual camera;
a second image generation process for generating a second image in the three-dimensional virtual space containing a second object outside an imaging area of the first virtual camera, based on a second virtual camera that moves in conjunction with the first virtual camera; and
an image combining process for generating a game image through combining the first and second images.

2. The non-transitory computer-readable storage medium according to claim 1,
wherein the first image generation process comprises using a Z-buffer to generate the first image, and
wherein the image combining process comprises: enlarging or reducing a texture constituting the second image based on a depth value stored in the Z-buffer for a corresponding position in the first image; and generating the game image through combining the enlarged or reduced second image with the first image.

3. The non-transitory computer-readable storage medium according to claim 1,
wherein the image combining process comprises: horizontally shifting a texture of a predetermined area in the second image; and then combining the second image with the first image.

4. The non-transitory computer-readable storage medium according to claim 3, wherein the image combining process comprises: referring to a reference image containing one or more horizontally extending lines; horizontally shifting the texture of the predetermined area corresponding to the lines contained in the reference image; and then combining the second image with the first image.

5. The non-transitory computer-readable storage medium according to claim 4, wherein the image combining process comprises vertically scrolling the one or more horizontally extending lines contained in the reference image.

6. The non-transitory computer-readable storage medium according to claim 1,
wherein the image combining process comprises: changing an enlargement factor of a texture for each of a plurality of channels constituting the second image; and then generating the game image through combining the second image with the first image.

7. The non-transitory computer-readable storage medium according to claim 1,
wherein the image combining process comprises: determining dark and bright sections of the first object based on a virtual light source in the three-dimensional virtual space and on a normal vector to a surface constituting the first object; and shading an area in the game image corresponding to the dark section.

8. The non-transitory computer-readable storage medium according to claim 7, wherein the shading is not applied to an area combined with an area in the second image with a predetermined brightness or higher, in the image combining process.

9. The non-transitory computer-readable storage medium according to claim 1,
wherein the first image generation process comprises using a Z-buffer to generate the first image,
wherein the second image generation process comprises generating a plurality of second images with different mipmap levels, and
wherein the image combining process comprises: determining a first mipmap level of a texture corresponding to the second object based on a depth value stored in the Z-buffer for a corresponding area in the first image; choosing the determined first mipmap level for a first area having a predetermined depth value; choosing a second mipmap level with lower resolution than the determined first mipmap level for a second area with a depth value other than the predetermined depth value; and combining textures corresponding to the chosen mipmap levels with the first image.

10. A game apparatus comprising a processor and a memory coupled thereto, the processor being configured to control the game apparatus to at least perform:
a player character control process for controlling a player character in a field in a three-dimensional virtual space based on an operation input;
a first virtual camera movement process for moving a first virtual camera according to a movement of the player character;
a first image generation process for generating a first image in the three-dimensional virtual space containing a first object constituting the field, based on the first virtual camera;
a second image generation process for generating a second image in the three-dimensional virtual space containing a second object outside an imaging area of the first virtual camera, based on a second virtual camera that moves in conjunction with the first virtual camera; and
an image combining process for generating a game image through combining the first and second images.

11. The game apparatus according to claim 10,
wherein the first image generation process comprises using a Z-buffer to generate the first image, and
wherein the image combining process comprises: enlarging or reducing a texture constituting the second image based on a depth value stored in the Z-buffer for a corresponding position in the first image; and generating the game image through combining the enlarged or reduced second image with the first image.

12. The game apparatus according to claim 10,
wherein the image combining process comprises: horizontally shifting a texture of a predetermined area in the second image; and then combining the second image with the first image.

13. The game apparatus according to claim 12,
wherein the image combining process comprises: referring to a reference image containing one or more horizontally extending lines; horizontally shifting the texture of the predetermined area corresponding to the lines contained in the reference image; and then combining the second image with the first image.

14. The game apparatus according to claim 13,
wherein the image combining process comprises vertically scrolling the one or more horizontally extending lines contained in the reference image.

15. The game apparatus according to claim 10,
wherein the image combining process comprises: changing an enlargement factor of a texture for each of a plurality of channels constituting the second image; and then generating the game image through combining the second image with the first image.

16. The game apparatus according to claim 10,
wherein the image combining process comprises: determining dark and bright sections of the first object based on a virtual light source in the three-dimensional virtual space and on a normal vector to a surface constituting the first object; and shading an area in the game image corresponding to the dark section.

17. The game apparatus according to claim 16,
wherein the shading is not applied to an area combined with an area in the second image with a predetermined brightness or higher, in the image combining process.

18. The game apparatus according to claim 10,
wherein the first image generation process comprises using a Z-buffer to generate the first image,
wherein the second image generation process comprises generating a plurality of second images with different mipmap levels, and
wherein the image combining process comprises: determining a first mipmap level of a texture corresponding to the second object based on a depth value stored in the Z-buffer for a corresponding area in the first image; choosing the determined first mipmap level for a first area having a predetermined depth value; choosing a second mipmap level with lower resolution than the determined first mipmap level for a second area with a depth value other than the predetermined depth value; and combining textures corresponding to the chosen mipmap levels with the first image.

19. A game system comprising a server apparatus and a user terminal connected to each other via a network,
the user terminal comprising a processor and a memory coupled thereto, the processor being configured to control the user terminal to at least perform:
an input process for accepting an operation input from a user;
a communications process for sending input operation information to the server apparatus as well as receiving game information sent from the server apparatus; and
a display process for displaying a game image,
the server apparatus comprising a processor and a memory coupled thereto, the processor being configured to control the server apparatus to at least perform:
a communications process for receiving operation information sent from the user terminal as well as sending game information to the user terminal;
a player character control process for controlling a player character in a field in a three-dimensional virtual space based on operation information of the user;
a first virtual camera movement process for moving a first virtual camera according to a movement of the player character;
a first image generation process for generating a first image in the three-dimensional virtual space containing a first object constituting the field, based on the first virtual camera;
a second image generation process for generating a second image in the three-dimensional virtual space containing a second object outside an imaging area of the first virtual camera, based on a second virtual camera that moves in conjunction with the first virtual camera; and
an image combining process for generating a game image through combining the first and second images.

20. The game system according to claim 19,
wherein the first image generation process comprises using a Z-buffer to generate the first image, and
wherein the image combining process comprises: enlarging or reducing a texture constituting the second image based on a depth value stored in the Z-buffer for a corresponding position in the first image; and generating the game image through combining the enlarged or reduced second image with the first image.

21. The game system according to claim 19,
wherein the image combining process comprises: horizontally shifting a texture of a predetermined area in the second image; and then combining the second image with the first image.

22. The game system according to claim 21,
wherein the image combining process comprises: referring to a reference image containing one or more horizontally extending lines; horizontally shifting the texture of the predetermined area corresponding to the lines contained in the reference image; and then combining the second image with the first image.

23. The game system according to claim 22,
wherein the image combining process comprises vertically scrolling the one or more horizontally extending lines contained in the reference image.

24. The game system according to claim 19,
wherein the image combining process comprises: changing an enlargement factor of a texture for each of a plurality of channels constituting the second image; and then generating the game image through combining the second image with the first image.

25. The game system according to claim 19,
wherein the image combining process comprises: determining dark and bright sections of the first object based on a virtual light source in the three-dimensional virtual space and on a normal vector to a surface constituting the first object; and shading an area in the game image corresponding to the dark section.

26. The game system according to claim 25,
wherein the shading is not applied to an area combined with an area in the second image with a predetermined brightness or higher, in the image combining process.

27. The game system according to claim 19,
wherein the first image generation process comprises using a Z-buffer to generate the first image,
wherein the second image generation process comprises generating a plurality of second images with different mipmap levels, and
wherein the image combining process comprises: determining a first mipmap level of a texture corresponding to the second object based on a depth value stored in the Z-buffer for a corresponding area in the first image; choosing the determined first mipmap level for a first area having a predetermined depth value; choosing a second mipmap level with lower resolution than the determined first mipmap level for a second area with a depth value other than the predetermined depth value; and combining textures corresponding to the chosen mipmap levels with the first image.

28. A game method for generating a game image using a computer of an information processing apparatus, the game method comprising the steps of:
the computer controlling a player character in a field in a three-dimensional virtual space based on an operation input;
the computer moving a first virtual camera according to a movement of the player character;
the computer generating a first image in the three-dimensional virtual space containing a first object constituting the field, based on the first virtual camera;
the computer generating a second image in the three-dimensional virtual space containing a second object outside an imaging area of the first virtual camera, based on a second virtual camera that moves in conjunction with the first virtual camera; and
the computer generating a game image through combining the first and second images.

29. The game method according to claim 28,
wherein the first image generation step comprises using a Z-buffer to generate the first image, and
wherein the game image generation step comprises: enlarging or reducing a texture constituting the second image based on a depth value stored in the Z-buffer for a corresponding position in the first image; and generating the game image through combining the enlarged or reduced second image with the first image.

30. The game method according to claim 28,
wherein the game image generation step comprises: horizontally shifting a texture of a predetermined area in the second image; and then combining the second image with the first image.

31. The game method according to claim 30,
wherein the game image generation step comprises: referring to a reference image containing one or more horizontally extending lines; horizontally shifting the texture of the predetermined area corresponding to the lines contained in the reference image; and then combining the second image with the first image.

32. The game method according to claim 31,
wherein the game image generation step comprises vertically scrolling the one or more horizontally extending lines contained in the reference image.

33. The game method according to claim 28,
wherein the game image generation step comprises: changing an enlargement factor of a texture for each of a plurality of channels constituting the second image; and then generating the game image through combining the second image with the first image.

34. The game method according to claim 28,
wherein the game image generation step comprises: determining dark and bright sections of the first object based on a virtual light source in the three-dimensional virtual space and on a normal vector to a surface constituting the first object; and shading an area in the game image corresponding to the dark section.

35. The game method according to claim 34,
wherein the shading is not applied to an area combined with an area in the second image with a predetermined brightness or higher, in the game image generation step.

36. The game method according to claim 28,
wherein the first image generation step comprises using a Z-buffer to generate the first image,
wherein the second image generation step comprises generating a plurality of second images with different mipmap levels, and
wherein the game image generation step comprises: determining a first mipmap level of a texture corresponding to the second object based on a depth value stored in the Z-buffer for a corresponding area in the first image; choosing the determined first mipmap level for a first area having a predetermined depth value; choosing a second mipmap level with lower resolution than the determined first mipmap level for a second area with a depth value other than the predetermined depth value; and combining textures corresponding to the chosen mipmap levels with the first image.
